(19) United States
(12) Patent Application Publication
(10) Pub. No.: US 2016/0140978 A1
(43) Pub. Date: May 19, 2016

(54) Customizable Local Media Mixing And Stream Selection In Group Communications

(71) Applicant: QUALCOMM Incorporated, San Diego, CA (US)

(72) Inventors: Sandeep SHARMA, San Diego, CA (US); Vijay Anandrao SURYAVANSHI, San Diego, CA (US); Kirankumar ANCHAN, San Diego, CA (US)

(21) Appl. No.: 14/546,749

(22) Filed: Nov. 18, 2014

(51) Int. Cl. G10L 21/0332; H04W 24/02; G10L 21/0208; H04W 4/08

(52) U.S. Cl. CPC G10L 21/0332; H04W 4/08; H04W 24/02; G10L 21/0208; G10L 2021/02087

(57) ABSTRACT

Systems, methods, and devices for managing audio streams in a group communication session. A processor of a receiving communication device may send to a transmitting communication device an instruction to adjust a gain of an audio stream of the transmitting communication device via a feedback communication link. A processor of the transmitting communication device may receive the instruction and may adjust the gain of the audio stream responsive to the instruction. The processor of the transmitting communication device may transmit the audio stream using the adjusted gain.

### BACKGROUND

Wireless communication may be provided as interconnect communication or dispatch communication. Interconnect communication is typically full duplex, for example, “cellular” communications and circuit-switched communications. Dispatch communication is typically half-duplex, for example, push-to-talk (PTT) or “walkie-talkie” communications. PTT communication sessions may include two or more participants, each registered with an application server. The application server provides presence information to each participant and performs floor mediation functions for the communication session. A PTT communication session involving more than two participants may be referred to as a group call or a group communication session.

In a group communication session involving multiple participants (i.e., N-way group communication), a communication stream may be transmitted from one participant to multiple other participants. Communications may be conveyed over a communication network using a protocol such as Real Time Protocol (RTP) or Secure Real Time Protocol (SRTP). In conjunction with RTP or SRTP, control information may be conveyed using a protocol such as Real Time Control Protocol (RTCP). Multiple communication streams of the group communication session may be mixed and delivered to each participant. In some embodiments, communication streams may be mixed at a central server before being directed to each participant. In some embodiments, communication streams may be mixed and individually controlled by a receiving communication device by a local mixer or equalizer.

Variations in the hardware or software of each mobile communication device may introduce bias into a communication stream transmitted by a communication device. For example, differences in microphone sensitivity or audio processing on the transmitting communication device, such as gain boosting, may result in a higher amplitude or gain of a transmitted communication stream than is the case for other devices within the group communication (i.e., the communication stream may be relatively louder). When multiple communication streams are mixed together by each participating device, differences in amplitude or gain among the various communication streams may cause the voices from participants using devices with lower amplitude or gain communication streams to be partially or completely in audible or drowned out by the voices from participants with higher amplitude or gain devices. Lower amplitude or gain communication streams may also be partially or completely suppressed by general cross-talk occurring among multiple communication devices participating in the group communication session.

### SUMMARY

The various embodiments include methods of managing audio streams in a group communication session, which may be implemented in network elements including a wireless device and a server, and may include sending, by a receiving communication device to a transmitting communication device, an instruction to adjust a gain of an audio stream of the transmitting communication device in which the instruction is sent via a feedback communication link, receiving the instruction by the transmitting communication device via the feedback communication link, the transmitting communication device adjusting the gain of the audio stream responsive to the instruction, and transmitting the audio stream from the transmitting communication device using the adjusted gain. In an embodiment, the receiving communication device may receive the audio stream over a communication link that is different than the feedback communication link.

In an embodiment, the methods may further include receiving, by the receiving communication device from a server, information indicating an availability of a plurality of audio streams, sending, by the receiving communication device to the server, a signal selecting the audio stream from among the plurality of audio streams, and receiving the selected audio stream from the server at the receiving communication device. In an embodiment, the methods may include receiving, by the receiving communication device from a server, information indicating an availability of a plurality of audio streams, sending, by the receiving communication device to the server, a signal selecting the audio stream and at least one other audio stream from among the plurality of audio streams, and receiving unmixed from the server the selected audio stream and the at least one other audio stream at the receiving communication device. In an embodiment, the methods may include storing the audio stream when the adjusted gain is less than a threshold gain.

In an embodiment, storing the audio stream may include sending, from the receiving communication device to a server, an instruction to store the audio stream when the instruction to adjust the gain of the audio stream of the transmitting communication device specifies a gain that is less than the threshold gain, and storing the audio stream in a server in communication with the transmitting communication device and the receiving communication device. In an embodiment, storing the audio stream may include storing the audio stream in the receiving communication device. In an embodiment, the instruction to adjust a gain of the audio stream of the transmitting communication device may include feedback signaling, which may include an RTCP header. In an embodiment, a server in communication with the receiving communication device and the transmitting communication device may ignore the instruction sent via the feedback communication link.

Further embodiments include a receiving communication device including a processor configured with processor-executable instructions to perform operations of the methods described above. Further embodiments include a transmitting communication device including a processor configured with processor-executable instructions to perform operations of the methods described above. Further embodiments include a system for managing audio streams in a group communication session, including a receiving communication device, a transmitting communication device, and an application server, each of which are configured to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram illustrating a communication system suitable for use with the various embodiments.

FIGS. 2A-2D are component block diagrams illustrating communication systems suitable for use with the various embodiments.

FIG. 3 is another component block diagram illustrating a communication system suitable for use with the various embodiments.

FIG. 4 is a process flow diagram illustrating an aspect method of managing audio streams in a group communication session.

FIG. 5 is a process flow diagram illustrating another aspect method of managing audio streams in a group communication session.

FIG. 6 is a component block diagram of an example mobile device suitable for use with the various aspects.

FIG. 7 is a component block diagram of an example server suitable for use with various aspects.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

The various embodiments provide methods and communication systems to enable one communication device in a group communication to send a signal to a second communication device in the group communication configured to cause the second communication device to adjust its audio gain in transmitted audio streams. Such signals may be transmitted through an overhead or other channel different from the main audio group communication channel, and may be relayed through a server mediating the group communication. In this manner, participants in a group communication can adjust the audio gain of one or more of the other participants' communication devices so that all participants may have a similar volume level on the receiving side. Thus, sound level adjustments may be affected by the communication devices participating in the group communication without requiring the mediating server to adjust or control any audio streams.

The word “exemplary” is used herein to mean “serving as an example, instance, or illustration.” Any implementation described herein as “exemplary” is not necessarily to be construed as preferred or advantageous over other implementations.

The terms “communication device” and “mobile communication device” are used interchangeably herein to refer generally to any one or all of cellular telephones, smart phones, tablet computers, Internet enabled cellular telephones, Wi-Fi enabled electronic devices, personal data assistants (PDAs), laptop computers, personal computers, wireless accessory devices, wireless peripheral devices, and similar electronic devices equipped with a short-range radio (e.g., a Bluetooth® radio, a Peanut® radio, a Wi-Fi radio, etc.) and/or a wide area network connection (e.g., an LTE, 3G or 4G wireless wide area network transceiver or a wired connection to the Internet). Thus, reference to a particular type of computing device as being a communication device or a mobile communication device is not intended to limit the scope of the claims unless a particular type of mobile device or mobile communication device is specifically recited.

Different cellular and mobile communication services and standards are available or contemplated in the future, all of which may implement and benefit from the various embodiments. Such services and standards include, e.g., Third Generation Partnership Project (3GPP), Long Term Evolution (LTE) systems, third generation wireless mobile communication technology (3G), fourth generation wireless mobile communication technology (4G), Global System For Mobile Communications (GSM), Universal Mobile Telecommunications System (UMTS), 3GSM, General Packet Radio Service (GPRS), Code Division Multiple Access (CDMA) systems (e.g., cdmaOne), Enhanced Data Rates for GSM evolution (EDGE), Advanced Mobile Phone System (AMPS), digital AMPS (IS-136/TDMA), Evolution-Data Optimized (EV-DO), Digital Enhanced Cordless Telecommunications (DECT), Worldwide Interoperability for Microwave Access (WiMAX), Wireless Local Area Network (WLAN), Wi-Fi Protected Access I & II (WPA, WPA2), and Integrated Digital Enhanced Network (iDEN). Each of these technologies involves, for example, the transmission and reception of voice, data, signaling, and/or content messages. Any references to terminology and/or technical details related to an individual telecommunication standard or technology are for illustrative purposes only, and are not intended to limit the scope of the claims to a particular communication system or technology unless specifically recited in the claim language.

In a group communication session with three or more participants, a communication stream may be transmitted from each participant to multiple other participants. Communication streams of the group communication session may be mixed and rendered for output by each mobile communication device participating in the session. In some embodiments, communication streams may be mixed at an application server before being directed to each participant. In some embodiments, communication streams may be mixed and individually controlled by a receiving communication device by a local mixer or equalizer.

Variations in the hardware or software of each mobile communication device may introduce variations in the amplitude or quality of a communication stream transmitted by a communication device. For example, differences in microphone sensitivity, or audio processing on the transmitting communication device such as gain boosting, may result in a higher amplitude or gain of a transmitted communication stream than is the case for other devices within the group communication. When multiple communication streams are mixed together by each participating device (or by a server and delivered to each participating receiving communication device), the relative differences in amplitude or gain among the various communication streams may cause the voices from participants using devices with lower amplitude or gain communication streams to be partially or completely inaudible by the voices from participants with higher amplitude or gain devices. Lower amplitude or gain communication streams may also be partially or completely suppressed by general cross-talk occurring among multiple communication devices participating in the group communication session.

In overview, various embodiments provide methods implemented by a processor executing on a mobile communication device to manage audio streams in a group communication session stack in which a receiving mobile communication device participating in a group communication session sends an instruction to a transmitting mobile communication device communication in the group communication session to instruct the transmitting mobile communication device to adjust a gain of an audio stream. The receiving communication device may send the instruction over a feedback communication link different than an audio or data communication link over which it receives the audio stream.

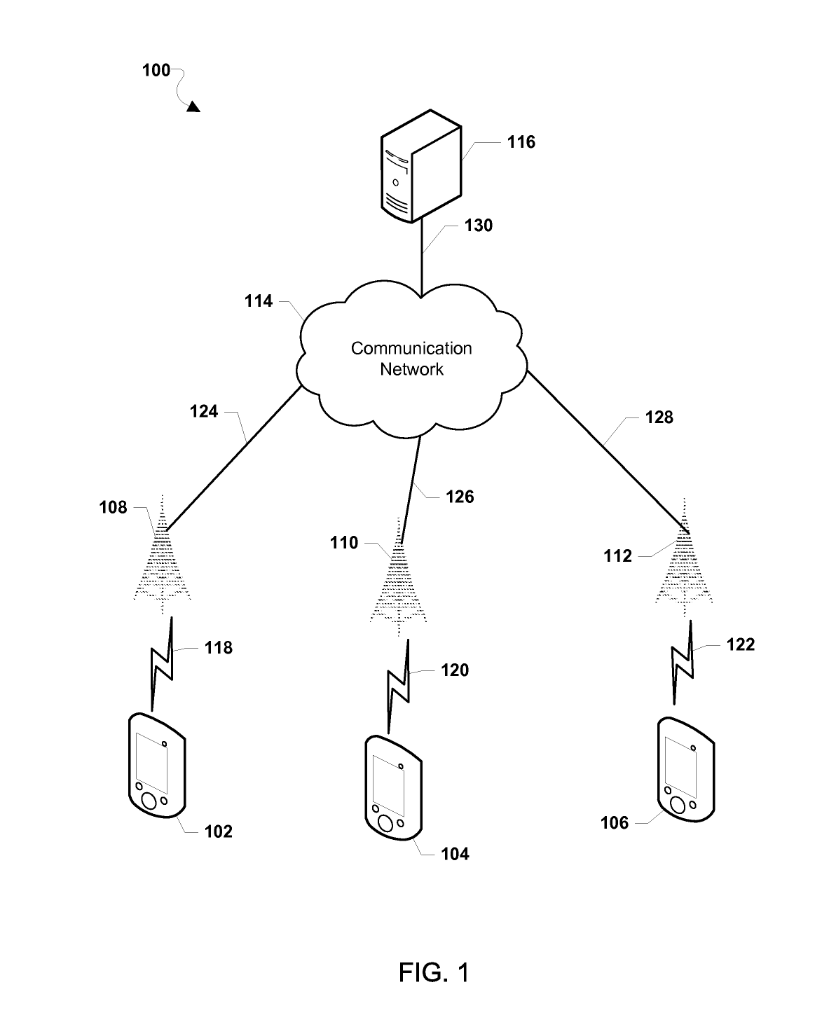

FIG. 1 illustrates a system 100 suitable for use with the various embodiments. The system 100 may include mobile communication devices 102, 104, and 106, base stations 108, 110, and 112, a communication network 114, and an application server 116. For ease of reference only three mobile devices 102, 104, and 106 are illustrated in FIG. 1 and referred to in the descriptions of the various embodiments. However, the embodiments and the claims are equally applicable to any number of mobile devices.

Mobile communication devices 102, 104, and 106 may communicate with the communication network 114 via the base stations 108, 110, and 112, respectively, over communication links 118, 120, and 122, respectively. The communication links 118, 120, and 122 may include cellular connections that may be made through two-way wireless communication links using a wireless radio access technology (RAT) such as LTE, WiMAX, CDMA, TDMA, Wideband CDMA, GSM, and other mobile telephony communication technologies. A communication link may include one or more frequency bands, and a frequency band may include one or more logical channels. While the communication links 118, 120, and 122 are illustrated as single links, in some embodiments the mobile communication devices may communicate with their respective base stations using two or more RATs over two or more frequency bands.

The base stations 108, 110, and 112 may communicate with the communication network 114 over wired and/or wireless communication links 124, 126, and 128. Each of the base stations 108, 110, and 112 may include a network node capable of providing wireless communications to the mobile communication devices 102, 104, and 106, and may include a base transceiver station, a radio base station, an eNodeB device, or an enhanced eNodeB device. The communication links 124, 126, and 128 may include wired or wireless communication links such as fiber optic backhaul links, microwave backhaul links, and other similar communication links.

The application server 116 may communicate with the communication network 114 over a communication link 130. The application server 116 may control the setup and maintenance of a communication session over the communication network 114 among communication devices such as the mobile communication devices 102, 104, and 106. The application server 116 may include a PTT dispatch application server (such as a QChat application server or an iDEN application server), a dispatch call controller (DCC), a mobile switching center (MSC), a mobility management entity (MME), or another similar network node. For dispatch communications, the dispatch application server 116 may utilize a dispatch communications protocol such as iDEN (Integrated Digital Enhanced Network), or QChat. The application server may also include a dispatch console or similar device capable of controlling the setup and maintenance of a communication session over the communication network 114.

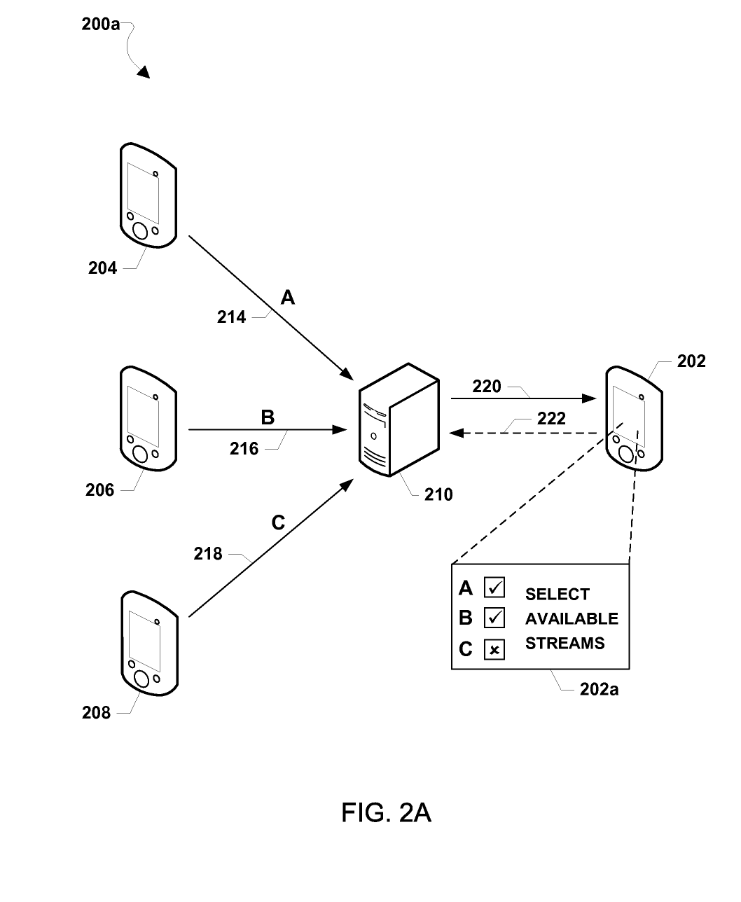

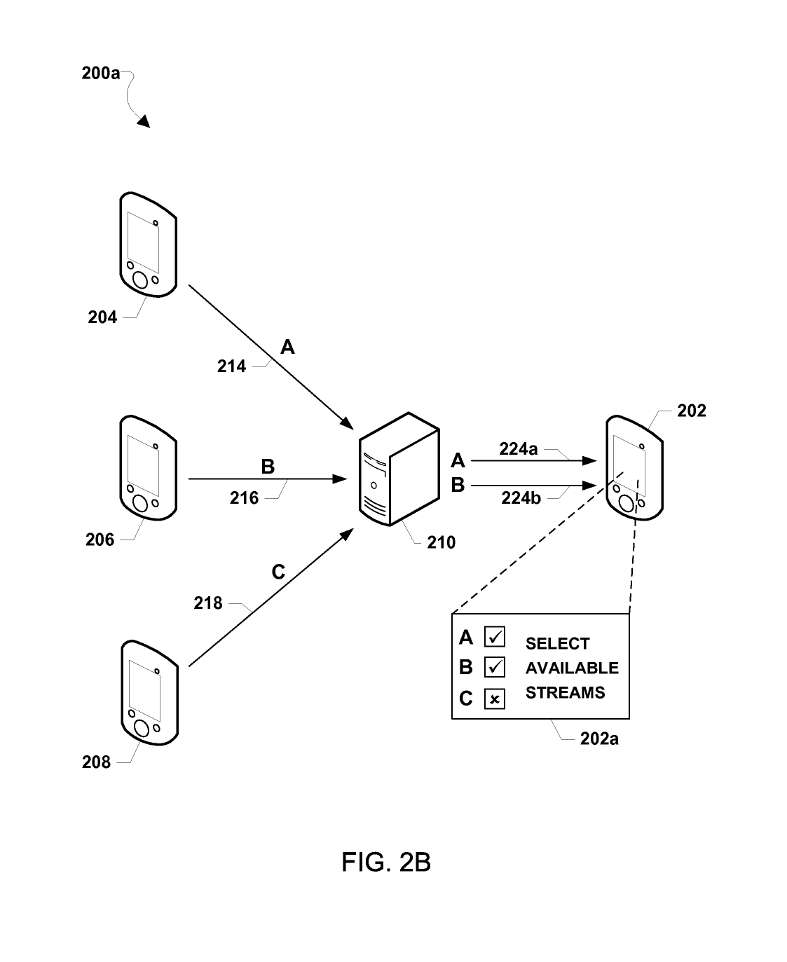

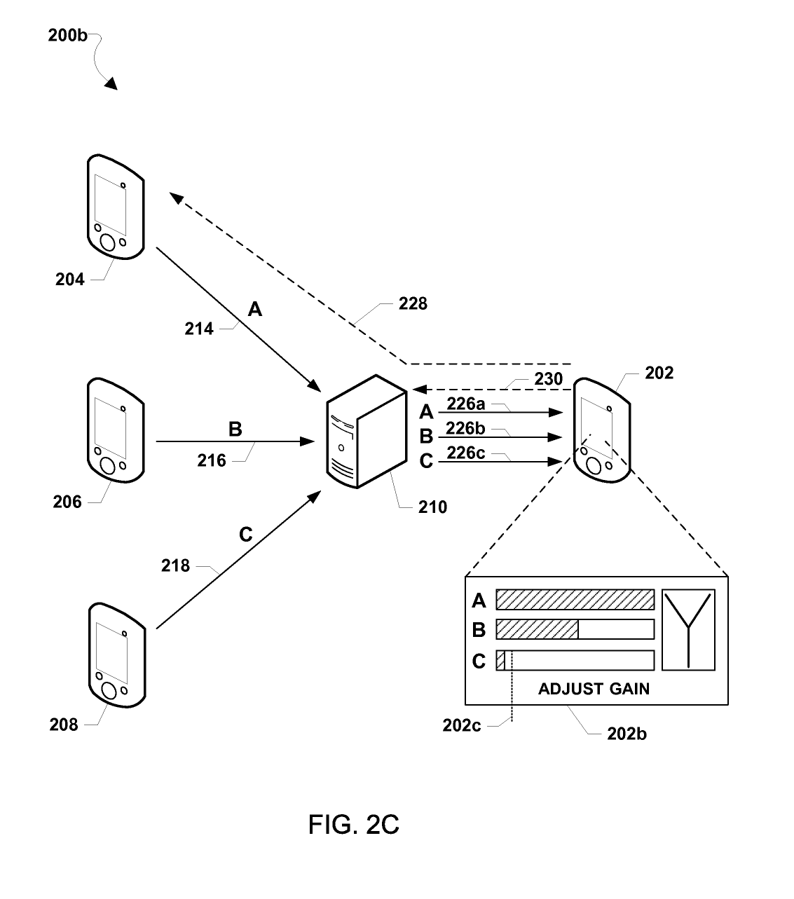

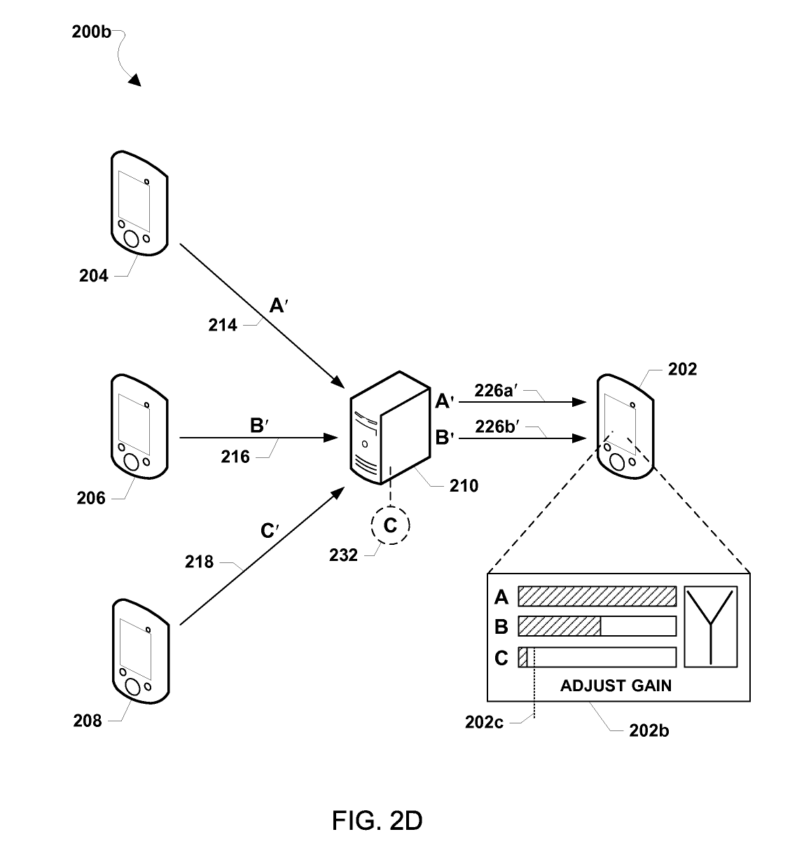

FIGS. 2A and 2B illustrate a system 200a suitable for use with the various embodiments. The system 200a may include mobile communication devices 202, 204, 206, and 208, and an application server 210. Each mobile communication device may register with the application server 210 to participate in a group communication session including the other mobile communication devices. The application server may send information to each mobile communication device indicating the availability of an audio stream from each of the other mobile communication devices (e.g., presence information, an inbound audio stream notification, or some other information). For ease of reference four mobile devices 202, 204, 206, and 208 are illustrated in FIG. 2 and referred to in the descriptions of the various embodiments, but the embodiments and the claims are equally applicable to any number of mobile devices.

A mobile communication device may transmit an audio stream to the server over communication link, such as an audio communication link or data communication. For example, the mobile communication device 204 may transmit an audio stream A to the server over a communication link 214. Similarly, the mobile communication device 206 may transmit an audio stream B to the server over a communication link 216, and the mobile communication device 208 may transmit an audio stream C to the server over a communication link 218. Each audio stream may include a unicast audio stream (as may be used in a PTT system), a full duplex audio stream (as may be used in an interconnect communication system), or another audio stream format. The server may provide information 220 indicating the availability of a plurality of audio streams, for example, audio streams A, B, and C, to a participating mobile communication device, for example the mobile communication device 202. In some embodiments, the mobile communication device 202 may request the information indicating the availability of audio streams from the server. In some embodiments the mobile communication device 202 may receive information indicating the availability of audio streams from the server without actively making a request, for example, by periodic notification from the server. In some embodiments, the mobile communication device 202 may monitor one or more of the audio streams A, B, and C. Monitoring refers to receiving one or more unmixed audio streams from the application server that have been selected by the receiving mobile communication device.

Each mobile communication device may provide a user interface 202a through which a user of the mobile communication device can select one or more of the unmixed audio streams for receipt. For example, the mobile communication device 202 may provide a user interface 202a based on the information indicating the availability of audio streams A, B, and C. The mobile communication device may receive one or more selections through the user interface 202a, such as through a touch screen, keys, buttons, voice input, or other input, of one or more of the available audio streams. For example, as illustrated in FIG. 2A, audio streams A and B have been selected for receipt by the communication device 202, and audio stream C has not been selected for receipt.

The mobile communication device 202 may send a signal 222 to the server 210 indicating the selection of the one or more audio streams. As illustrated in FIG. 2B, in response to receiving the signal 222 from the mobile communication device 202, the application server 210 may send unmixed audio streams A and B 224a, 224b to the mobile communication device 202. The mobile communication device 202 may receive later an input selecting audio stream C, or deselecting audio stream A and/or B, and the mobile communication device 202 may send another signal to the application server 210 to update the audio stream selections of the mobile communication device 202.

FIGS. 2C and 2D illustrates a system 200b according to another embodiment. The system 200b may include the mobile communication devices 202, 204, 206, and 208, and the application server 210. The application server may send information to each mobile communication device indicating an availability of an audio stream from each of the other mobile communication devices (which information may include presence information, an inbound audio stream notification, or some other information).

The mobile communication devices 204, 206, and 208 may transmit audio streams A, B, and C, respectively, to the server over a communication link. Each audio stream may include a unicast audio stream (as may be used in a PTT system), a full duplex audio stream (as may be used in an interconnect communication system), or another audio stream format. The application server 210 may receive the audio streams A, B, and C from each of the mobile communication devices 204, 206, and 208, and the server may send each of the audio streams A, B, and C separately (i.e., unmixed) to the mobile communication device 202. The mobile communication device 202 may monitor one or more of the audio streams A, B, and C, received by the mobile communication device 202 as audio streams 226a, 226b, and 226c, respectively.

Variations in the hardware or software (e.g., differences in microphone sensitivity, audio processing, etc.) of the mobile communication devices 204, 206, and 208 may introduce variations in the amplitude or quality of an audio stream transmitted by a communication device. When the audio streams A, B, and C from each of the mobile communication devices are mixed together, the relative differences in amplitude or gain among the various communication streams may cause, e.g., the voices from participants using devices with lower amplitude or gain communication streams to be partially or completely inaudible relative to the voices from participants with higher amplitude or gain devices. Lower amplitude or gain communication streams may also be partially or completely suppressed by general cross-talk occurring among multiple communication devices participating in the group communication session.

Each mobile communication device may run an application through which a gain of one or more of the other mobile communication devices may be controlled. The gain may include a volume of an outbound audio stream (i.e., an audio stream transmitted from a mobile communication device), a microphone sensitivity of the transmitting mobile communication device, and/or a volume or gain boost or other signal processing applied by a transmitting mobile communication device. For example, the mobile communication device 202 may run the application, represented by a user interface 202b, which may send commands 228 to one or more of the transmitting mobile communication devices (e.g., 204) to adjust the audio stream gain of the transmitting mobile communication device. As one example, the user interface 202b may receive an input or inputs setting a gain of audio stream A at approximately 100%, setting a gain of audio stream B at approximately 50%, and setting a gain of audio stream C at approximately 0% (i.e., audio stream C may be effectively muted for the mobile communication device 202). When the gain of an audio stream is set in the user interface 202b, a processor of the mobile communication device 202 may send an instruction to adjust the gain of the audio stream to the transmitting mobile communication device.

The receiving communication device may transmit the instruction over a feedback communication link. The feedback communication link may include a control channel, a feedback control channel, or another communication link that is distinct from the communication link over which the mobile communication device 202 may receive one or more audio streams from the server. The feedback communication link may also be different from the communication link by which a transmitting mobile communication device (e.g., mobile communication device 204) transmits an audio stream to the server. For example, the mobile communication device 202 may send an instruction to the mobile communication device 204 responsive to a setting or input received by the user interface 202b to instruct the mobile communication device 204 to adjust a gain of its outbound audio stream via the feedback communication link 228. Similarly, the mobile communication device 202 may send an instruction to the mobile communication device 206 and/or the mobile communication device 208 responsive to a setting or input received by the user interface 202b to instruct the mobile communication device 206 or 208 to adjust a gain of its outbound audio stream via a feedback communication link. In some embodiments, the instruction may pass through the server, and the server may ignore the instruction (i.e., the server may not process the instruction). For example, the instruction may include header information, such as in an RTCP packet, RTSP packet, and the like, which may indicate that the instruction is intended for one of the transmitting mobile communication devices 204, 206, or 208. The server may process the portion of the header indicating the instruction's destination, and in response to the header information the server may ignore the instruction, and may merely pass on the instruction to the destination mobile communication device.

A transmitting mobile communication device may receive the instruction from the receiving mobile communication device, and in response to the instruction, the transmitting mobile communication device may adjust the gain of its outbound audio stream. For example, a processor of the mobile communication device 204 may receive the instruction from the mobile communication device 202 to increase the gain of its transmitted audio stream to approximately 100%. In response, the processor of the mobile communication device 204 may adjust the gain of its transmitted audio stream to approximately 100%. As another example, a processor of the mobile communication device 206 may receive the instruction from the mobile communication device 202 to reduce the gain of its transmitted audio stream to approximately 50%. In response, the processor of the mobile communication device 206 may adjust the gain of its transmitted audio stream to approximately 50%. As another example, the mobile communication device 208 may receive the instruction from the mobile communication device 202 to reduce the gain of its transmitted audio stream to approximately 0%, and in response the mobile communication device 206 may adjust the gain of its transmitted audio stream to approximately 0%. As illustrated in FIG. 2D, each of the mobile communication devices 204, 206, and 208 may then transmit gain-adjusted audio streams A′, B′, and C′, respectively. The mobile communication device 202 may monitor one or more of the gain-adjusted audio streams, such as audio streams 226a′ and 226b′, received by the mobile communication device 202. While the mobile communication device 202 is illustrated sending an instruction to mobile communication device 204, any of the mobile communication devices may send a gain instruction to any of the other mobile communication devices in the group communication session.

In some embodiments, when a transmitting mobile communication device is instructed to reduce the gain of its outbound audio stream below a threshold, the audio stream may be stored by the application server 210. The stored audio stream may later be retrieved and played back. For example, the mobile communication device 202 may instruct the mobile communication device 208 to adjust the gain of its transmitted audio stream C to below a threshold 202c (e.g., a threshold level or a threshold gain). In some embodiments, when the mobile communication device 202 instructs another mobile communication device to adjust its gain below the threshold, the mobile communication device may also send an instruction 230 to the application server 210 to store the audio stream. The application server 210 may then store the audio stream having the adjusted gain that is less than the threshold gain (e.g., the server may store 232 the audio stream). For example, when the gain of the audio stream C is adjusted to below the threshold level, but to a gain that is greater than zero, the server may receive the audio stream from the mobile communication device 208. When the gain-adjusted audio streams A′, B′, and C′ are later mixed together, either by the server or by the mobile communication device 202, the audio level of the audio stream C′ may be reduced below audibility by the mixing process. In other words, reducing the gain of the transmitted audio stream C to below the threshold level may effectively mute the audio stream C′, particularly post-mixing. Since the gain of the audio stream C′ received by the server is greater than zero, the audio stream C′ may be buffered or stored by the server for later retrieval by, e.g., the mobile communication device 202.

In some embodiments, the systems and methods illustrated in FIGS. 2A-2D may be used in combination. For example, the mobile communication device 202 may select the audio streams to receive, and the mobile communication device 202 may also send an instruction to a transmitting mobile communication device to adjust the gain of its outbound audio stream.

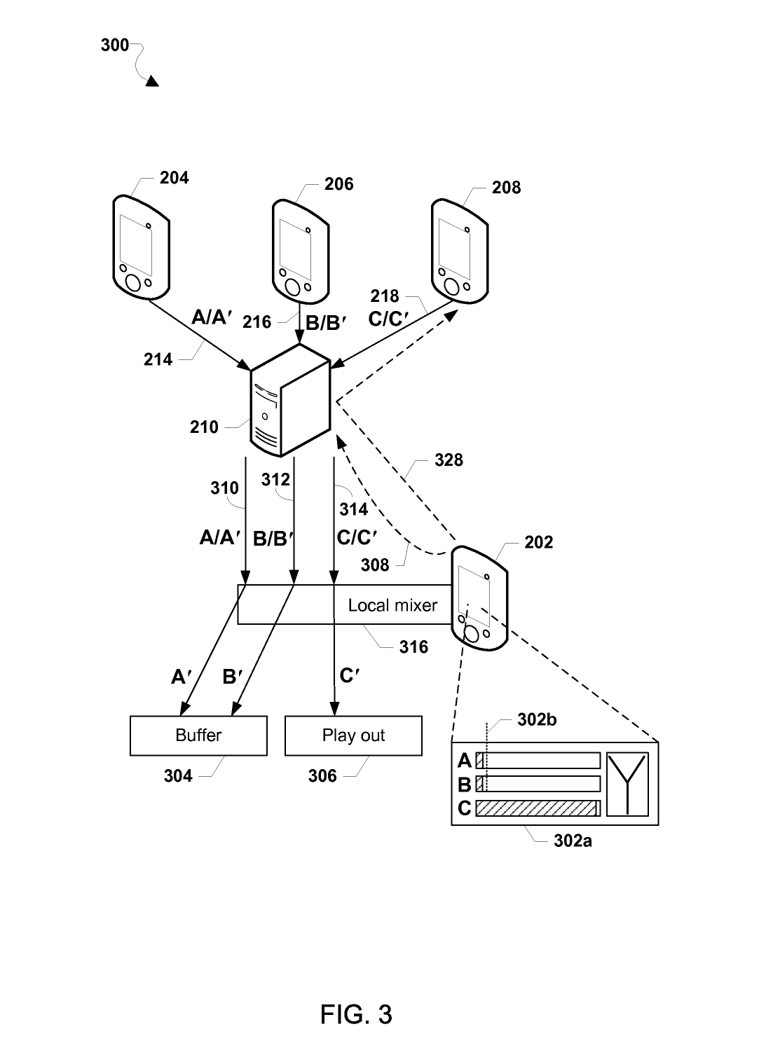

FIG. 3 illustrates a system 300 suitable for use with the various embodiments. The system 300 may include mobile communication devices 202, 204, 206, 208, each of which may register with the application server 210 to participate in a group communication session including the other mobile communication devices. For ease of reference four mobile devices 202, 204, 206, and 208 are illustrated in FIG. 3 and referred to in the descriptions of the various embodiments, but the embodiments and the claims are equally applicable to any number of mobile devices.

A mobile communication device may transmit an audio stream to the server over a communication link, such as an audio communication link or data communication. For example, the mobile communication device 204 may transmit the audio stream A to the server over the communication link 214. Similarly, the mobile communication device 206 may transmit the audio stream B to the server over the communication link 216, and the mobile communication device 208 may transmit the audio stream C to the server over the communication link 218. Each audio stream may include a unicast audio stream (as may be used in a PTT system), a full duplex audio stream (as may be used in an interconnect communication system), or another audio stream format. The application server may send information to each mobile communication device indicating the availability of an audio stream from each of the other mobile communication devices (e.g., presence information, and inbound audio stream notification, or some other information), and a mobile communication device may instruct the application server to provide one or more of the audio stream to the mobile communication device. For example, the mobile communication device 202 may send a request 308 to the application server 210 to instruct the application server to send audio streams A, B, and C to the mobile communication device 202.

Each mobile communication device may run an application through which a gain of one or more of the other mobile communication devices may be controlled. For example, the mobile communication device 202 may run the application represented by a user interface 302a, which may send commands to one or more of the transmitting mobile communication devices to adjust an audio stream gain. As illustrated in user interface 302a, a gain of audio stream C may be set at approximately 100%, and a gain of audio streams A and B may be set below a threshold level 302b. When the gain of an audio stream is set in the user interface 302a, a processor of the mobile communication device 202 may send an instruction to adjust the gain of the audio stream to the transmitting mobile communication device.

The receiving communication device may transmit the instruction over a feedback communication link. The feedback communication link may include a control channel, a feedback control channel, or another communication link that is distinct from the communication link over which the mobile communication device 202 may receive one or more audio streams from the server. The feedback communication link may also be different from the communication link by which a transmitting mobile communication device (e.g., mobile communication device 208) transmits an audio stream to the server. For example, the mobile communication device 202 may send an instruction to the mobile communication device 208 responsive to a setting or input received by the user interface 302a to instruct the mobile communication device 208 to adjust a gain of its outbound audio stream via the feedback communication link 328.

Similarly, the mobile communication device 202 may send an instruction to the mobile communication device 204 or the mobile communication device 206 responsive to a setting or input received by the user interface 302a to instruct the mobile communication device 204 or 206 to adjust a gain of its outbound audio stream via a feedback communication link.

In some embodiments, the instruction may pass through the server, and the server may ignore the instruction (i.e., the server may not process the instruction). For example, the instruction may include header information, such as in an RTCP packet, RTSP packet, and the like, which may indicate that the instruction is intended for one of the transmitting mobile communication devices 204, 206, or 208. The server may process the portion of the header indicating the instruction's destination, and in response to the header information the server may ignore the instruction, and may merely pass on the instruction to the destination mobile communication device.

A transmitting mobile communication device may receive the instruction from the receiving mobile communication device, and in response to the instruction, the transmitting mobile communication device may adjust the gain of its outbound audio stream. For example, the mobile communication devices 204 and 206 may receive an instruction from the mobile communication device 202 to reduce the gain of their respective transmitted audio streams to below the threshold level 302b. In response, each mobile communication device 204 and 206 may adjust the gain of its transmitted audio stream to below the threshold level.

The application server may receive the gain-adjusted audio streams A′, B′, and C′ from each of the mobile communication devices 204, 206, and 208, and responsive to the instruction 308 the server may send each of the audio streams A′, B′, and C′ separately to the mobile communication device 202. Each of the separate audio streams may include an unmixed unicast audio stream. The mobile communication device 202 may receive each of the unmixed audio streams A′, B′, and C′ and may perform a mixing operation on one or more of the audio streams by a local mixer 316. The local mixer may include hardware and/or software on the mobile communication device 202 configured to mix and/or perform other processing on the audio streams A′, B′, and C′. Received audio streams may be rendered for presentation (e.g., played out 306) by the mobile communication device 202, e.g., by decoding and/or processing the received audio streams.

In some embodiments, when a transmitting mobile communication device is instructed to reduce the gain of its outbound audio stream below a threshold, the audio stream may be stored by the mobile communication device 202. The stored audio stream may later be retrieved and played back. For example, the mobile communication device 202 may instruct the mobile communication devices 204 and 206 to adjust the respective gains of their transmitted audio streams A and B to below the threshold 302b.

The mobile communication device 202 may store the audio streams A′ and B′ in a buffer 304 when the adjusted gain is less than the threshold. The buffer 304 may include a memory device configured to store one or more audio streams. For example, when the gain of the audio streams A′ and B′ are adjusted to below the threshold level, but to a gain that is greater than zero, the communication device 202 may receive the audio streams and may store them in the buffer 304. Each of the audio streams A′ and B′ may be later retrieved for playback, alone or together, by the mobile communication device 202.

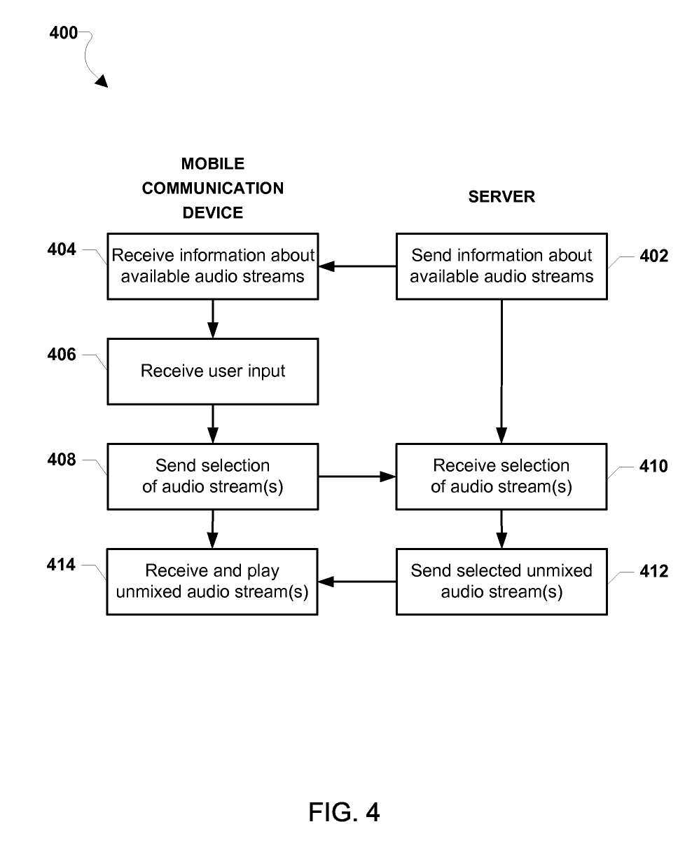

FIG. 4 is a process flow diagram illustrating an embodiment method 400 for managing audio streams in a group communication session. The method 400 may be implemented by a processor of a network element, such as a processor of the application server 116 of FIG. 1 or a processor of the application server 210 of FIGS. 2A-3, or by a processor of a mobile communication device, such as a processor of the mobile communication device 102, 104, or 106 of FIG. 1, or the mobile communication device 202, 204, 206, or 208 of FIGS. 2A-3, or any another similar processor.

In block 402, the processor of the server may send information indicating an availability of audio streams to a mobile communication device. In block 404, the processor of the mobile communication device may receive the information indicating the available audio streams. In block 406, the processor of the mobile communication device may receive a user input selecting one or more of the available audio streams. In block 408, the processor of the mobile communication device may send a signal indicating the selection of the one or more available audio streams to the server. In block 410, the processor of the server may receive the signal indicating the selection of the one or more available audio streams. In block 412, the processor of the server may send the selected audio streams to the mobile communication device. The server may send the selected audio streams as separate, unmixed unicast audio streams. In block 414, the processor of the mobile communication device may receive and play back the unmixed audio streams. In some embodiments, the mobile communication device may perform a mixing operation on the unicast audio streams.

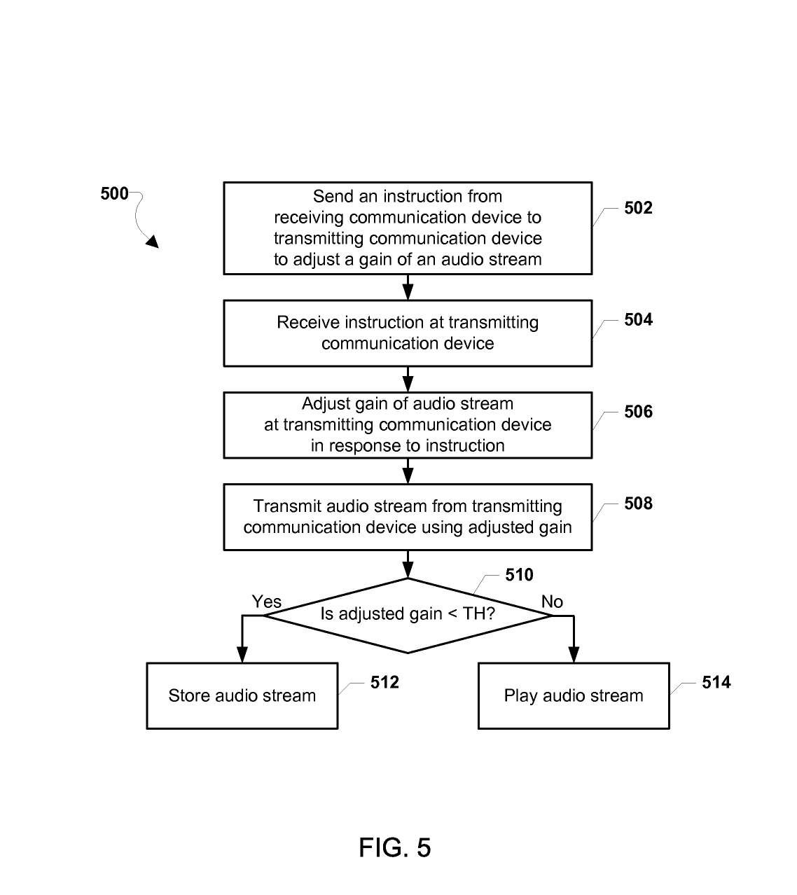

FIG. 5 is a process flow diagram illustrating an embodiment method 500 for managing audio streams in a group communication session. The method 500 may be implemented by a processor of a network element, such as a processor of the application server 116 of FIG. 1 or a processor of the application server 210 of FIGS. 2A-3, or by a processor of a mobile communication device, such as a processor of the mobile communication device 102, 104, or 106 of FIG. 1, or the mobile communication device 202, 204, 206, or 208 of FIGS. 2A-3, or any another similar processor.

In block 502, a mobile communication device may send an instruction to a transmitting communication device to adjust a gain of an audio stream of the transmitting communication device via a feedback communication link. The receiving mobile communication device may run an application through which a gain of one or more of the other mobile communication devices may be controlled. When the gain of an audio stream is set in the application, a processor of the receiving mobile communication device may send an instruction to adjust the gain of the audio stream to the transmitting mobile communication device. The receiving communication device may transmit the instruction over a feedback communication link. The feedback communication link may include a control channel, a feedback control channel, or another communication link that is distinct from the communication link over which the receiving mobile communication device may receive one or more audio streams.

In block 504, the transmitting mobile communication device may receive the instruction from the receiving mobile communication device. In response to the instruction, the transmitting mobile communication device may adjust the gain of its outbound audio stream in block 506. For example, the mobile communication device 206 may receive an instruction from the mobile communication device 202 to reduce adjust the gain of its transmitted audio stream, and in response, the mobile communication device 206 may adjust the gain of its transmitted audio stream to the instructed level.

In block 508, the transmitting communication device may transmit the audio stream using the adjusted gain. The transmitted audio stream may be received from the transmitting communication device by an application server as well as by the receiving communication device.

In determination block 510, the communication device processor may determine whether the adjusted gain of the audio stream is below a threshold level. When the adjusted gain of the audio stream is below the threshold level (i.e., determination block 510=“Yes”), the processor may store the audio stream in a memory device, e.g., a buffer, in block 512. When the adjusted gain of the audio stream is not below the threshold level (i.e., determination block 510=“No”), the processor may render the audio stream may be for presentation in block 514.

In some embodiments, the audio stream may be stored by the application server. In some embodiments, when a transmitting mobile communication device is instructed to reduce the gain of its outbound audio stream below a threshold, the audio stream may be stored by the receiving mobile communication device. Regardless of its storage location, the stored audio stream may later be retrieved and played back by the receiving mobile communication device.

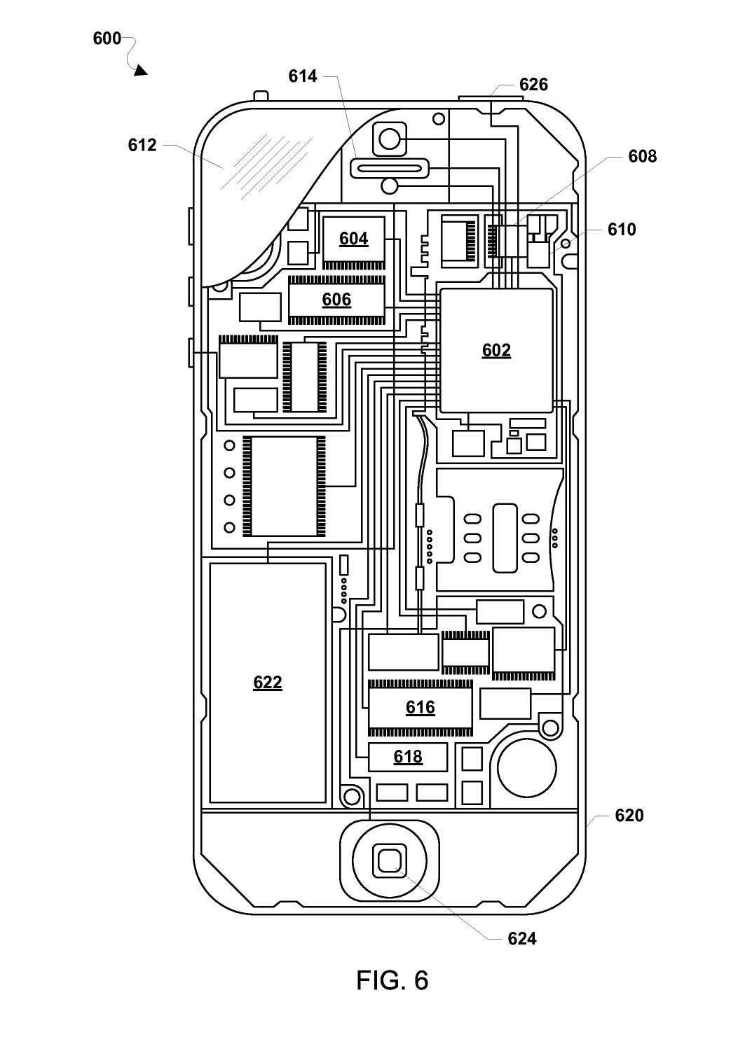

Various embodiments may be implemented in any of a variety of communication devices, an example of which (e.g., a mobile communication device 600) is illustrated in FIG. 6. In various embodiments, the mobile communication device 600 may be similar to the mobile communication devices 102, 104, and 106 as described with reference to FIG. 1, or to the mobile communication devices 202, 204, 206 and 208 as described with reference to FIGS. 2A-3.

The mobile communication device 600 may include a processor 602 coupled to a touchscreen controller 604 and an internal memory 606. The processor 602 may be one or more multi-core integrated circuits designated for general or specific processing tasks. The internal memory 606 may be volatile or non-volatile memory, and may also be secure and/or encrypted memory, or unsecure and/or unencrypted memory, or any combination thereof. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the mobile communication device 600 need not have touch screen capability.

The mobile communication device 600 may have two or more radio signal transceivers 608 (e.g., Peanut, Bluetooth, Zigbee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile communication device 600 may include one or more cellular network wireless modem chip(s) 616 coupled to the processor and antennae 610 that enable communication via two or more cellular networks via two or more radio access technologies.

The mobile communication device 600 may include a peripheral device connection interface 618 coupled to the processor 602. The peripheral device connection interface 618 may be singularly configured to accept one type of connection, or may be configured to accept various types of physical and communication connections, common or proprietary, such as USB, FireWire, Thunderbolt, or PCIe. The peripheral device connection interface 618 may also be coupled to a similarly configured peripheral device connection port (not shown).

The mobile communication device 600 may also include speakers 614 for providing audio outputs. The mobile communication device 600 may also include a housing 620, constructed of a plastic, metal, or a combination of materials, for containing all or some of the components discussed herein. The mobile communication device 600 may include a power source 622 coupled to the processor 602, such as a disposable or rechargeable battery. The rechargeable battery may also be coupled to the peripheral device connection port to receive a charging current from a source external to the mobile communication device 600. The mobile communication device 600 may also include a physical button 624 for receiving user inputs. The mobile communication device 600 may also include a power button 626 for turning the mobile communication device 600 on and off.

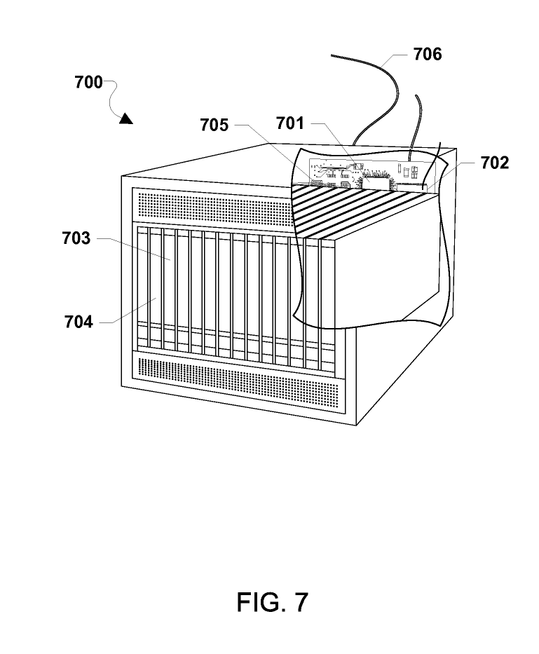

Portions of the embodiment methods may be accomplished in a client-server architecture with some of the processing occurring in a server, such as maintaining databases of normal operational behaviors, which may be accessed by a computing device processor while executing the embodiment methods. Such embodiments may be implemented on any of a variety of commercially available server computing devices, such as the server 700 illustrated in FIG. 7. In various embodiments, the server 700 may be similar to the server 116 as described with reference to FIG. 1, and to the server 210 as described with reference to FIGS. 2A-3. Such a server 700 typically includes a processor 701 coupled to volatile memory 702 and a large capacity nonvolatile memory, such as a disk drive 703. The server 700 may also include a floppy disc drive, compact disc (CD) or DVD disc drive 704 coupled to the processor 701. The server 700 may also include network access ports 705 coupled to the processor 701 for establishing data connections with a network 706, such as a local area network coupled to other broadcast system computers and servers. The processor 701 may be any programmable microprocessor, microcomputer or multiple processor chip or chips that can be configured by software instructions (applications) to perform a variety of functions, including the functions of the various embodiments described above. Typically, software applications may be stored in the internal memory 702, 703 before they are accessed and loaded into the processor 701. The processor 701 may include internal memory sufficient to store the application software instructions.

The processors 601 and 701 may be any programmable microprocessor, microcomputer or multiple processor chip or chips that can be configured by software instructions (applications) to perform a variety of functions, including the functions of various embodiments described below. In some mobile devices, multiple processors 601 may be provided, such as one processor dedicated to wireless communication functions and one processor dedicated to running other applications. Typically, software applications may be stored in the internal memory 601 and 701 before they are accessed and loaded into the processor 601 and 701. The processor 601 and 701 may include internal memory sufficient to store the application software instructions.

Various embodiments may be implemented in any number of single or multi-processor systems. Generally, processes are executed on a processor in short time slices so that it appears that multiple processes are running simultaneously on a single processor. When a process is removed from a processor at the end of a time slice, information pertaining to the current operating state of the process is stored in memory so the process may seamlessly resume its operations when it returns to execution on the processor. This operational state data may include the process's address space, stack space, virtual address space, register set image (e.g. program counter, stack pointer, instruction register, program status word, etc.), accounting information, permissions, access restrictions, and state information.

A process may spawn other processes, and the spawned process (i.e., a child process) may inherit some of the permissions and access restrictions (i.e., context) of the spawning process (i.e., the parent process). A process may be a heavy-weight process that includes multiple lightweight processes or threads, which are processes that share all or portions of their context (e.g., address space, stack, permissions and/or access restrictions, etc.) with other processes/threads. Thus, a single process may include multiple lightweight processes or threads that share, have access to, and/or operate within a single context (i.e., the processor's context).

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of managing audio streams in a group communication session, comprising:
sending, by a receiving communication device to a transmitting communication device, an instruction to adjust a gain of an audio stream of the transmitting communication device, wherein the instruction is sent via a feedback communication link;
receiving the instruction by the transmitting communication device via the feedback communication link;
adjusting, by the transmitting communication device, the gain of the audio stream responsive to the instruction; and
transmitting the audio stream from the transmitting communication device using the adjusted gain.

2. The method of claim 1, wherein the receiving communication device receives the audio stream over a communication link that is different than the feedback communication link.

3. The method of claim 1, further comprising:
receiving, by the receiving communication device from a server, information indicating an availability of a plurality of audio streams;
sending, by the receiving communication device to the server, a signal selecting the audio stream from among the plurality of audio streams; and
receiving the selected audio stream from the server at the receiving communication device.

4. The method of claim 1, further comprising:
receiving, by the receiving communication device from a server, information indicating an availability of a plurality of audio streams;
sending, by the receiving communication device to the server, a signal selecting the audio stream and at least one other audio stream from among the plurality of audio streams; and
receiving unmixed from the server the selected audio stream and the at least one other audio stream at the receiving communication device.

5. The method of claim 1, further comprising:
storing the audio stream when the adjusted gain is less than a threshold gain.

6. The method of claim 5, wherein storing the audio stream comprises:
sending, from the receiving communication device to a server, an instruction to store the audio stream when the instruction to adjust the gain of the audio stream of the transmitting communication device specifies a gain that is less than the threshold gain; and
storing the audio stream in a server in communication with the transmitting communication device and the receiving communication device.

7. The method of claim 5, wherein storing the audio stream comprises storing the audio stream in the receiving communication device.

8. The method of claim 1, wherein the instruction to adjust a gain of the audio stream of the transmitting communication device comprises feedback signaling.

9. The method of claim 8, wherein the feedback signaling comprises an RTCP header.

10. The method of claim 1, wherein a server in communication with the receiving communication device and the transmitting communication device ignores the instruction sent via the feedback communication link.

11. A receiving communication device, comprising:
a processor configured with processor-executable instructions to perform operations comprising:
sending to a transmitting communication device an instruction to adjust a gain of an audio stream of the transmitting communication device, wherein the instruction is sent via a feedback communication link; and
receiving an indication that the transmitting communication device has adjusted the gain of the audio stream responsive to the instruction.

12. The receiving communication device of claim 11, wherein the processor is configured with processor-executable instructions to perform operations such that the instruction is sent via a feedback communication link that is different than a communication link for receiving the audio stream.

13. The receiving communication device of claim 11, wherein the processor is configured with processor-executable instructions to perform operations further comprising:
receiving from a server information indicating an availability of a plurality of audio streams;
sending to the server a signal selecting the audio stream from among the plurality of audio streams; and
receiving the selected audio stream from the server.

14. The receiving communication device of claim 11, wherein the processor is configured with processor-executable instructions to perform operations further comprising:
receiving from a server information indicating an availability of a plurality of audio streams;
sending to the server a signal selecting the audio stream and at least one other audio stream from among the plurality of audio streams; and
receiving unmixed from the server the selected audio stream and the at least one other audio stream.

15. The receiving communication device of claim 11, wherein the processor is configured with processor-executable instructions to perform operations such that the instruction to adjust a gain of the audio stream of the transmitting communication device comprises feedback signaling.

16. The receiving communication device of claim 15, wherein the processor is configured with processor-executable instructions to perform operations such that the feedback signaling comprises an RTCP header.

17. The receiving communication device of claim 11, wherein the processor is configured with processor-executable instructions to perform operations further comprising:
sending to a server an instruction to store the audio stream when the instruction to adjust the gain of the audio stream of the transmitting communication device specifies an adjusted gain that is less than a threshold gain.

18. The receiving communication device of claim 11, wherein the processor is configured with processor-executable instructions to perform operations further comprising storing the audio stream when the adjusted gain of the audio stream is less than a threshold gain.

19. A transmitting communication device, comprising:
a processor configured with processor-executable instructions to perform operations comprising:
receiving, from a receiving communication device via a feedback communication link, an instruction to adjust a gain of an audio stream of the transmitting communication device;
adjusting the gain of the audio stream responsive to the instruction; and
transmitting the audio stream from the transmitting communication device using the adjusted gain.

20. The transmitting communication device of claim 19, wherein the processor is configured with processor-executable instructions to perform operations such that the instruction is received via a feedback communication link that is different than a communication link for transmitting the audio stream.

21. The transmitting communication device of claim 19, wherein the processor is configured with processor-executable instructions to perform operations such that the instruction to adjust a gain of the audio stream comprises feedback signaling.

22. The transmitting communication device of claim 21, wherein the processor is configured with processor-executable instructions to perform operations such that the feedback signaling comprises an RTCP header.

23. A system for managing audio streams in a group communication session, comprising:
a receiving communication device;
a transmitting communication device; and
an application server, in communication with the receiving and transmitting communication devices;
wherein the receiving communication device includes a processor configured with processor-executable instructions to perform operations comprising:
sending to the transmitting communication device an instruction to adjust a gain of an audio stream of the transmitting communication device, wherein the instruction is sent via a feedback communication link;
wherein the transmitting communication device includes a processor configured with processor-executable instructions to perform operations comprising:
receiving, from the receiving communication device via the feedback communication link, the instruction to adjust a gain of the audio stream;
adjusting the gain of the audio stream responsive to the instruction; and
transmitting the audio stream to the application server from the transmitting communication device using the adjusted gain; and
wherein the application server includes a processor configured with processor-executable instructions to perform operations comprising:
storing the audio stream when the adjusted gain is below a threshold gain.

24. The system of claim 23, wherein the processor of the application server is configured with processor-executable instructions to perform operations further comprising ignoring the instruction sent from the receiving communication device to the transmitting communication device via the feedback communication link.

25. The system of claim 23, wherein the feedback communication link is different than a communication link over which the transmitting communication device transmits the audio stream.

26. The system of claim 23, wherein the processor of the application server is configured with processor-executable instructions to perform operations such that storing the audio stream comprises:
receiving, from the receiving communication device, an instruction to store the audio stream when the adjusted gain of the instruction to adjust the gain of the audio stream of the transmitting communication device is less than the threshold gain; and
storing the audio stream in response to the instruction to store the audio stream.

27. The system of claim 23, wherein the processor of the receiving communication device is configured with processor-executable instructions to perform operations further comprising:
receiving, from the application server, information indicating an availability of a plurality of audio streams;
sending, to the application server, a signal selecting the audio stream from among the plurality of audio streams; and
receiving the selected audio stream from the application server.

28. The system of claim 23, wherein the processor of the receiving communication device is configured with processor-executable instructions to perform operations further comprising:
receiving, from the application server, information indicating an availability of a plurality of audio streams;
sending, to the application server, a signal selecting the audio stream and at least one other audio stream from among the plurality of audio streams; and
receiving unmixed from the application server the selected audio stream and the at least one other audio stream.
